(19) United States
(12) Patent Application Publication
(10) Pub. No.: US 2024/0407325 A1
(43) Pub. Date: Dec. 12, 2024

(54) CAT NEST

(71) Applicant: Pak Hei Wong, Dongguan (CN)

(72) Inventor: Pak Hei Wong, Dongguan (CN)

(21) Appl. No.: 18/207,194

(22) Filed: Jun. 8, 2023

(51) Int. Cl. A01K 1/035; A01K 15/02

(52) U.S. Cl. CPC A01K 1/0353; A01K 15/024

(57) ABSTRACT

A cat nest with a cat scratching board, comprising a cat nest main body and a cat scratching board; the cat nest main body and the cat scratching board are designed separately, which is convenient for the cat scratching board to be interchanged with a base of the cat nest made of other materials; the cat scratching board is a hollow porous structure, which enhances the air permeability of the bottom of the cat nest, and the porous vertical structure improves the strength and is not easy to collapse; the cat nest main body is a three-dimensional support structure, and the surface is a flexible fabric containing fillers to achieve a certain support effect, the bottom of the cat nest main body is designed as an elastic closure for fastening the cat scratching board and prevent it from loosening; the cat scratching board is an environmentally friendly recyclable raw material.

### TECHNICAL FIELD

The present application relates to the technical field of pet products, in particular to a cat nest with a detachable cat scratching board.

### BACKGROUND

Cat nest is a resting tool for pet cats. With the strengthening of the consumption power of the pet market, consumers are increasingly dependent and sustenance on pet cats, which makes cat nest a huge consumer market as a pet tool. At present, some cat nest tools on the market are simple in materials, single in function and similar in shape.

Conventional cat nests use ordinary materials and are simple in shape. They can only be used for rest, and cannot be used in multiple scenarios. For cats, they are not playable.

### SUMMARY

The main purpose of the present application is to provide a cat nest, which aims to solve the problem that the cat nest is suitable for multiple scenarios, increase the function and playability of the cat nest, and enhance the love of pet cats for the cat nest.

In order to achieve the above purpose, the present application provides that the cat nest comprises a cat nest main body and a detachable cat scratching board.

The cat scratching board and the main body of the cat nest are embedded structures, and the cat scratching board is a detachable structure.

The detachable cat scratching board is configured as a hollow porous structure, which has stronger structural strength, is not easy to collapse, and has better moisture-proof and air-permeable effects. The cat nest main body is a three-dimensional structure, and the shape of the cat nest main body can be changed; the bottom of the cat nest is made of waterproof and moisture-proof fabric; a bottom of the cat nest is configured as an elastic closing structure, the detachable cat scratching board can be fixed on the bottom of the cat nest, and the elastic closing structure can also fix other cat nest base materials.

Optionally, in one embodiment, the bottom of the cat nest is made of waterproof and moisture-proof fabric.

Optionally, in one embodiment, the cat scratching board fixed in the cat nest is made of environmentally friendly recyclable material corrugated paper, which is wound into but not limited to a shape of a disc or a square disc, so that the cat scratching board has high structural strength and is not easy to collapse; a porous structure inside the cat scratching board penetrates up and down to enhance air permeability, so as to prevent moisture and breathe freely.

Optionally, in one embodiment, the cat scratching board is fastened by the elastic closing structure at the bottom of the cat nest main body, which facilitates the replacement of other materials, and uses cotton material to keep warm in winter, which is suitable for different scenarios.

In the technical solution provided by the present application, a cat nest with detachable cat scratching board is arranged in the cat nest main body; the cat nest main body and the cat scratching board are designed separately, which is convenient for the cat scratching board to be interchanged with a base of the cat nest made of other materials; the cat scratching board is a hollow porous structure that penetrates up and down, which enhances the air permeability of the bottom of the cat nest, and has higher structural strength and is not easy to collapse; the cat scratching board is an environmentally friendly recyclable raw material, and the porous structure solves the moisture problem, avoids bacterial growth, and reduces the possibility of ringworm induced by moisture. The cat nest main body is a three-dimensional support structure, and the surface is a flexible fabric containing fillers to achieve a certain support effect, the bottom of the cat nest main body is designed as an elastic closure for fastening the cat scratching board and prevent it from loosening. The present application enhances the playability, breathability and safety of the cat nest through the combination of the cat nest and the detachable cat scratching board.

### BRIEF DESCRIPTION OF DRAWINGS

One or more embodiments are exemplified by corresponding drawings, and these exemplifications are not construed as limiting the embodiments, and elements with the same reference numerals in the drawings represent similar elements. Unless otherwise stated, the Figures in the drawings are not limited to scale.

FIG. 1 is a structural diagram of an embodiment of the cat nest of the present application;

FIG. 2 is an exploded structural schematic diagram of an embodiment of the cat nest of the present application;

FIG. 3 is a structural schematic diagram of a cat scratching board.

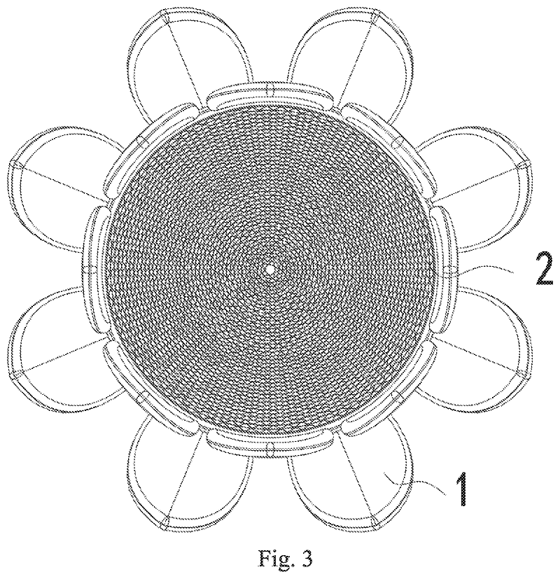

Reference signs: 1. Cat nest main body; 2. Detachable cat scratching board.

### DETAILED DESCRIPTION

The following will clearly and completely describe the technical solutions in the implementation of the present application with reference to the accompanying drawings in the embodiments of the present application. Apparently, the described embodiments are only some of the embodiments of the present application, not all of them.

Examples of the described embodiments are shown in the drawings, wherein like or similar reference numerals designate like or similar elements or elements having the same or similar function throughout. The embodiments described below by referring to the figures are exemplary, and are intended to explain the present application, and should not be construed as limiting the present application.

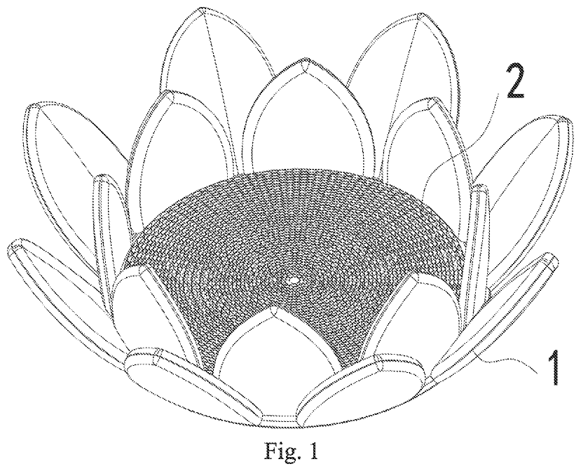

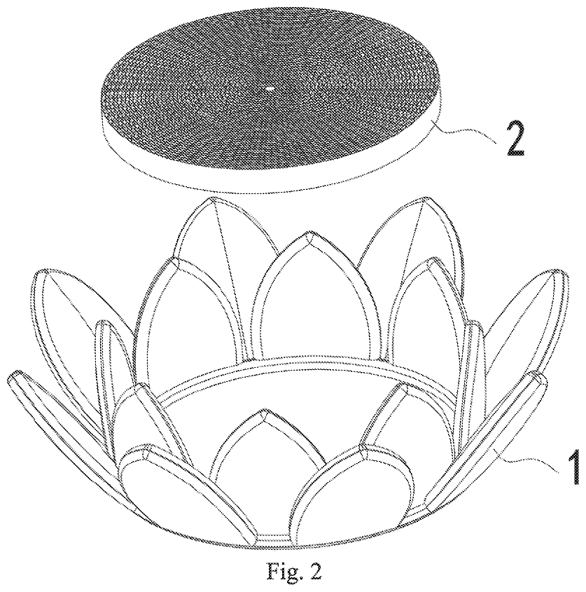

Please refer to FIG. 1 and FIG. 2, the cat nest main body (1) is made into a three-dimensional shape through fabrics and fillings, with a unique shape, which is different from conventional cat nests and enhances the entertainment properties; the bottom of the cat nest main body is designed as an elastic closure for fastening the cat scratching board (2), the cat scratching board (2) is a hollow porous structure that penetrates up and down, which enhances the air permeability of the bottom of the cat nest, and has higher structural strength and is not easy to collapse; the cat scratching board is an environmentally friendly recyclable raw material, and the porous structure solves the moisture problem, avoids bacterial growth, and reduces the possibility of ringworm induced by moisture. The present application enhances the playability, breathability and safety of the cat nest through the combination of the cat nest (1) and the detachable cat scratching board (2).

The above embodiments are only used to illustrate the technical solutions of the present application, rather than to limit them. Under the idea of the present application, the technical features in the above embodiments or different embodiments can also be combined, the steps can be implemented in any order, and there are many other changes in different aspects of the above-mentioned application, for the sake of brevity, which are not provided in the details. Although the present application has been described in detail with reference to the aforementioned embodiments, those skilled in the art should understand that: it can still modify the technical solutions described in the aforementioned embodiments, or perform equivalent replacements for some of the technical features. However, these modifications or replacements do not make the essence of the corresponding technical solutions depart from the scope of the technical solutions of the embodiments of the present application.

What is claimed is:

1. A cat nest, comprising a cat nest main body (1) and a detachable cat scratching board (2), wherein
the detachable cat scratching board is configured as a hollow porous structure, which has stronger structural strength, is not easy to collapse, and has better moisture-proof and air-permeable effects;
a bottom of the cat nest is configured as an elastic closing structure, the detachable cat scratching board can be fixed on the bottom of the cat nest, and the elastic closing structure can also fix other cat nest base materials.

2. The cat nest according to claim 1, wherein the cat scratching board fixed in the cat nest is made of environmentally friendly recyclable material corrugated paper, which is wound into but not limited to a shape of a disc or a square disc, so that the cat scratching board has high structural strength and is not easy to collapse; a porous structure inside the cat scratching board penetrates up and down to enhance air permeability, so as to prevent moisture and breathe freely; the cat scratching board is fastened by the elastic closing structure at the bottom of the cat nest main body, which facilitates the replacement of other materials, and uses cotton material to keep warm in winter, which is suitable for different scenarios.

3. The cat nest according to claim 2, wherein the cat nest main body includes various frame structures, and various materials and fillers are used to construct a three-dimensional frame; the cat nest can realize a combination of the cat nest main body in various shapes and cat scratching boards.

4. The cat nest according to claim 3, wherein the cat nest main body comprises fabrics and inner fillers, and the bottom of the cat nest main body is connected by elastic closing sewing; the bottom of the cat nest is provided with waterproof and moisture-proof fabrics.
